(19) United States
(12) Patent Application Publication
(10) Pub. No.: US 2003/0189102 A1
(43) Pub. Date: Oct. 9, 2003

(54) A CODE BEARER

(76) Inventors: Marcus Kozica, Stockholm (SE); Vilhelm Gustavsson, Stockholm (SE)

Correspondence Address: PILLSBURY WINTHROP, LLP, P.O. BOX 10500, MCLEAN, VA, 22102, US

(21) Appl. No.: 10/162,206

(22) Filed: Jun. 5, 2002

(30) Foreign Application Priority Data
Mar. 26, 2002 (SE) 0200948-8

(51) Int. Cl. G06K 19/06

(52) U.S. Cl. 235/494

(57) ABSTRACT

The present invention relates to a code bearer, a data-coding device and a method for coding data onto a bearer, provided for manual reading of a first code followed by an input of the first code to a machine, said bearer comprising at least one numerical data field comprising the first code as a series of multiple figures. A second code is generically provided specifying the numerical data field with the first code through modulo arithmetic with a predetermined base, represented by at least one symbol accomplished through compressing each series of multiple figures in the at least one data field. The symbols are concatenated in a predetermined pattern for entering into the machine, wherein enhanced readability of the first code through the symbol pattern applied for the first code is accomplished, thus providing an aid for facilitated, protected and error-minimized input of data belonging to the first code into the machine/apparatus.

### TECHNICAL FIELD

The present invention pertains to a code bearer, a data-coding device and a method for coding of data onto a bearer for accomplishing a facilitated, secured and error-minimized entering of data into a machine.

### BACKGROUND ART

Huge amounts of data are daily being entered and processed electronically through networks for data or telecommunication such as the Internet. This data can, among other things, include different economic transactions, both on personal and corporate levels and related to such as payment orders, stock broking affairs, transfer of economic funds and the like. Online bookings and reservations, for example for travel and accommodation purposes and different registrations for membership purposes and such as online purchasing of goods and services and the like also contributes to the bulk of data continuously being exposed and processed on these networks.

The security and safe keeping of the online data is then of the utmost importance and a lot of effort and money is being put on minimizing the risk for unauthorized tampering of protected data over networks through a variety of security solutions. Errors can also occur due to mishandling when people are entering and processing data electronically if the wrong data is input. For example a person wanting to electronically pay an invoice might have to fill in 5 fields of data online, totaling as much as 50 characters in all to be entered correctly for achieving a payment in accordance to prerequisites.

In the year 2000 for example, well over 800 million payment order transactions where carried out on the Swedish market alone. The error rate for online payments in Sweden is typically about 1-1.5% and would probably not be much less in other countries. This results in high billing and invoicing costs. Some lobbyists are claiming that the total billing and invoicing cost amounts to about SEK 250 due to all the erroneous payments being made.

Furthermore problems arise when money due on a certain account at a certain date is electronically misplaced and maybe lost, transferred to an unknown account instead. Invoice providers may “unnecessarily” send out payment reminders with or without a penalty fee for delayed payment of their outstanding invoices. Payment providers as a consequence thereof may have to pay the same invoice twice and also with an extra fee for delayed payment. The extra time and effort involved with correcting such errors due to mishandling of data continuously contributes to both unnecessary expenses and irritations for individuals as well as corporations. The correctional activities involved are perceived as quite tedious and may sometimes also be very stressful for the people assigned to carry them out.

There seems to be a need for a more protected and facilitated way of entering secure data electronically for the purpose of avoiding problems mentioned above.

### SUMMARY OF THE DISCLOSED INVENTION

The present invention relates to a code bearer, a data-coding device and a method for coding of data onto a bearer. The invention thus enables for protected data to be easily handled in electronic environments incorporating an enhanced level of security against tampering by unauthorized entities.

A purpose of the invention is to provide an aid to facilitate the entering of data sequences electronically, e.g. to a machine such as a computerized device, to a network for data or telecommunication or the like.

Another purpose of the invention is to provide enhanced security when utilizing protected data electronically in environments where data is susceptible to be scanned and intercepted by unwanted entities for exploitation.

Yet another purpose of the invention is to provide a means for an error-minimized entering of data electronically, for reducing unnecessary correctional efforts and costs originating from the mishandling of electronic information.

To achieve aims and objectives the present invention provides a code bearer provided for manual reading of a first code followed by an input of the first code to a machine, said bearer comprising at least one numerical data field comprising the first code as a series of multiple figures. The code bearer is characterized in that it is provided a second code generically specifying the numerical data field with the first code through modulo arithmetic with a predetermined base, represented by at least one symbol accomplished through compressing each series of multiple figures in the at least one data field into the at least one symbol representing the series of multiple figures through the utilized base in the modulo arithmetic. The symbols are concatenated in a predetermined pattern for entering into the machine, wherein enhanced readability of the first code through the symbol pattern applied for the first code is accomplished, thus providing an aid for facilitated, protected and error-minimized input of data belonging to the first code into the machine.

In one embodiment of the code bearer according to the present invention, it is a piece of code-imprinted material.

In another embodiment of the code bearer according to the present invention, it is an electronic device connected to a display.

In yet another embodiment of the code bearer according to the present invention, it is an invoice or a bill.

In yet an embodiment of the code bearer according to the present invention, the comprised data fields contain data referring to at least one of account payable, account type, amount, due date of payment and reference number.

In an embodiment of the code bearer according to the present invention, the date during the 21^{st} century is determined by:

DATE=(yy*12+mm−1)*31+dd−1

0≦DATE≦37199 days.

In another embodiment of the code bearer according to the present invention, DATE is set to 0 for denoting a NULL entry of a date.

In embodiments of the code bearer according to the present invention, the code is implemented with a set of predefined account numbers minimizing the number of bits required and the account numbers are specified in a list of the most frequently occurring account numbers in each of two different payment systems utilized.

In a further embodiment of the code bearer according to the present invention, it is a receipt.

In yet a further embodiment of the code bearer according to the present invention, it is a receipt for a purchase of a product or service.

In other embodiments of the code bearer according to the present invention, it is a receipt for a registration of a travel, accommodation or membership.

In yet other embodiments of the code bearer according to the present invention, it is a credit card, a membership card, a driver's licence, a passport, an id-card or a social security card.

In an additional embodiment of the code bearer according to the present invention, the machine is a computerized device with a screen.

In still one embodiment of the system according to the present invention, the machine is a handheld computerized device with a display such as a PDA, a cellular telephone or the like.

In other embodiments of the code bearer according to the present invention the machine is connected to a network for data or telecommunication.

In a further embodiment of the code bearer according to the present invention, the predetermined pattern is a number of symbols provided in blocks.

In another embodiment of the code bearer according to the present invention, the coding scheme is reversed for decoding the second code back into the first code again upon entering the second code into the machine.

In one other embodiment of the code bearer according to the present invention, the second code is substantially shorter than the first code.

In still another embodiment of the code bearer according to the present invention, the first code substantially comprises numerals.

In still a further embodiment of the code bearer according to the present invention, the second code comprises letters from at least one alphabet, numerals or a combination of letters and numerals.

In yet an additional embodiment of the code bearer according to the present invention, the second code comprises an error detection symbol.

In yet one more embodiment of the code bearer according to the present invention, the error detection symbol is accomplished through adhering all the symbols in the second code through the modulo arithmetic with a predetermined base.

In yet further embodiments of the code bearer according to the present invention, an additional coding scheme is used for additional compression of the second code, multiple payment orders are summarized into a single code by an extension of the second code and the second code is computer readable through a scanning means.

The present invention further sets forth a data-coding device for generating a second code from a first code on a code bearer, said bearer comprising at least one numerical data field comprising the first code as a series of multiple figures. The device further comprises:

means for providing the second code via generically specifying the numerical data field with the first code through modulo arithmetic with a predetermined base;

means for compressing each series of multiple figures in the at least one data field into at least one symbol;

means for concatenating said symbols in a predetermined pattern for entering into a machine; and

wherein enhanced readability of the first code through the symbol pattern applied for the first code is accomplished, thus providing an aid for facilitated and error-minimized input of data connected to the first code into the machine.

In one embodiment of the data-coding device according to the present invention, it further comprises a printing means for printing the second code onto the bearer.

In another embodiment of the code bearer according to the present invention, it further comprises a decoder means for decoding the second code into the first code upon entering the second code into the machine.

In yet another embodiment of the data-coding device according to the present invention, it further comprises a field identifying means for identifying length-dynamic data fields and length static data fields.

In a further embodiment of the data-coding device according to the present invention, multiple length-dynamic data fields are arranged to be concatenated into a single length-dynamic data field.

In yet a further embodiment of the data-coding device according to the present invention, the length-dynamic data field is arranged to be positioned first when the length-dynamic and length-static data fields are concatenated.

In an alternative embodiment of the data-coding device according to the present invention, length-static data fields are concatenated when no length-dynamic data fields are identified.

The present invention further also sets forth a method for providing a code to a bearer, said bearer comprising at least one numerical data field comprising the first code as a series of multiple figures. The method further comprises the steps of:

providing a second code generically specifying the alphanumerical data field with the first code through modulo arithmetic with a predetermined base;

compressing each series of multiple figures in the at least one data field into the at least one symbol representing the series of multiple figures through the utilized base in the modulo arithmetic;

concatenating said symbols in a predetermined pattern for entering into the machine;

wherein enhanced readability of the first code through the symbol pattern applied for the first code is accomplished, thus providing an aid for facilitated, protected and error-minimized input of data connected to the first code into the machine.

In one embodiment of the method according to the present invention, the second code is printed onto the bearer.

In another embodiment of the method according to the present invention, the second code is provided electronically onto the bearer.

In a further embodiment of the method according to the present invention, the coding scheme is reversed for the second code to be decoded into the first code subsequent to entering the second code into the machine.

In still a further embodiment of the method according to the present invention, the decoded data is extracted onto the fields of an electronic copy of the code bearer provided on a screen of the machine and in correspondence to the data fields of the original code bearer.

In yet another embodiment of the method according to the present invention, length-dynamic data fields and length static data fields are identified.

In yet a further embodiment of the method according to the present invention, all length-dynamic data fields are concatenated into a single length-dynamic data field.

In still one embodiment of the method according to the present invention, the symbols from a length-dynamic data field are positioned first for the concatenation.

### BRIEF DESCRIPTION OF THE DRAWINGS

Henceforth reference is had to the attached figures for a better understanding of the present invention and its examples and embodiments, wherein:

FIG. 1 illustrates a flowchart 100, describing steps for identifying a coding scheme, according to one embodiment of the present invention;

FIG. 2 schematically illustrates an invoice 200 with data fields containing data to be coded for subsequent electronic entering into a machine/apparatus, according to one embodiment of the present invention.

### LEGEND

A handheld computerized device can be a laptop computer, a PDA or the like comprising cellular radio equipment or a WAP telephone device etc.

An open network for data communication can be the WWW or other like open networks, Intranet etc.

Data Part: The final code represents a set of data. A data part is simply one of these.

Data Field: At some stage during computation of the code sequence all information will be represented in a single sequence consisting of parts or “slots” each representing a data part. Such a “slot” is called a data field. A data field can be of dynamic length or not. If the final code for example where to reference a payment order, a data field representing an amount of a payment is typically length-dynamic since (in theory) any amount is possible. However a data field representing an account type is typically not length-dynamic.

Code Table: Each data field has its corresponding code table that specifies all possible values of each data part.

Order of Data Fields: In general it is possible to specify a code sequence as is but from a practical perspective it is sometimes more efficient to use a different “language”. If for instance the code were expressed in binary digits, i.e., 0 and 1, to use a hexadecimal representation would require fewer digits. There are more hexadecimal digits than binary digits but the code sequence would get shorter. If, in this example, the total number of binary digits would not be evenly dividable by four, a few i.e. one to three binary zeros would be automatically added to the beginning. Since the dynamic data field can't have a most significant digit of value zero and since the static data field very well can, it is required to place the dynamic data field first in the code sequence to be able to parse the sequence when decoding.

### DETAILED DESCRIPTION OF PREFERRED EMBODIMENTS

The present invention relates to a code bearer, a data-coding device and a method for coding of data onto a bearer for accomplishing a facilitated, secured and error-minimized entering of data into a machine/apparatus.

The invention aims at providing enhanced means for accomplishing a simplified and safe entering of secure data electronically with minimized risk of erroneous data being entered, through providing a scheme for coding of the data for example for use over networks for data or telecommunication such as the Internet, corporate Intranets and the like. In situations where there is a need for a safe, simple and error-minimized utilization of data, such as for online payments of invoices, where secure information like PIN codes, personal identification numbers, or social security numbers, numbers of personal bank accounts and such secure data need to be exposed electronically, the requirement of attaining a certain degree of safety for the like activities is essential for practicality and functionality reasons.

There is also the aspect of filling in electronic invoices or performing online registrations, bookings or purchases with the wrong data where the consequences could become apparent at a later time with extra costs and troubles consequently following with an initial mishandling of the data. Also, data such as credit card codes and numbers have to be protected from interception and unauthorized exploitation over digital networks, at banking machines or wherever these numbers and codes are exposed, for payment or withdrawal of money.

It is becoming evermore popular to perform online payments, online bookings of travel and accommodation, online purchasing of products and services, economic transactions including stock broking online, online distribution of information either directly to individual recipients according to database stored individual information or through mass distribution etc, over electronic networks due to their innate ability to handle enormous amounts of data with lightning speed and on a worldwide scale. Problems relating to such online activities originates as mentioned earlier in keeping secluded information protected from unauthorized usage and also in minimizing of erroneous entering of data. For example, for online payments, when filling in an invoice electronically there could be as much as 50 characters or more altogether in a number of fields on the electronic invoice, which all have to be filled out correctly lest the online payment will fail. The same problem applies when, for example, referring to a booking of a flight over the Internet, where series of data fields often have to be correctly filled out, partly with secure information, in order to accomplish the booking according to request. There is also a mistrust among many users towards giving out personal codes over open networks and the like and many persons are tired of the often long series of data needing to be entered for accomplishing what is desired.

Moreover the data, for example, on a flight ticket purchased from a certain travel agency, could be summarized and coded directly onto the ticket for facilitating the inputting of the ticket data, for example at an airport on departure. Thereby enabling homogeneous procedures for checking in passengers for example at airports, independent of the tickets appearance, which can differ quite significantly between different travel agencies thus allowing for such activities to be performed faster, smoother and with minimized risk for erroneous handling of the data.

The coding scheme of the present invention therefore defines a universal language to generically specify specific data.

The following paragraphs provide background information for one of the preferred embodiments of the present invention relating to online payment of invoices and bills.

Given a specific payment transfer several parties typically are involved. The payment process originates from a transaction or deal between two parties, the service provider and the customer. Following this transaction the service provider generates a database of accounts receivables and due payments. Typically this is done in an automated billing process. The service provider orders a third party to manage the invoicing process with the information in the database of due payments. The invoicing party formats the database according to the local payment infrastructure systems and standards and generates and sends the proper invoice to each specific customer. In general some customers have ordered a “direct debit” transfer in which case the invoicing party (not necessarily the same one) orders a withdrawal of the amount from a prescribed account. A transfer agent typically does this withdrawal, possibly after a formal accept from the customer by mail or by electronic means. The invoice received by the customer (not using a direct debit transfer) contains relevant specifications from the service provider and a formal payment order. The payment order in this particular example specifies the five following data fields:

Account payable.

Account type.

Amount.

Due date of payment.

Reference number unique to the service provider.

Wherein the reference number gives the service provider a unique reference to the specific invoice once the amount has been transferred in order to handle missing or erroneous payments.

The customer submits the payment order to his or hers payment agent either physically, e.g. by mail, through a teller machine or a customer representative, or electronically. In all these cases the five data fields specified above needs to be properly handed over to the payment agent. As of today there are several solutions addressing the need of error free transfer of this information. To mention a few:

The payment order can be read electronically by an “optical character recognition” (OCR) system. These are typically highly expensive and do often need a manual back up for unreadable orders.

The reference number usually contains a “check sum” in order to warn the person keying the number into the specific system if any mistakes are made. It is also customary to include a digit representing the total number of digits of the reference number.

The specific system can access a database of accounts payable hence giving reference to the service provider corresponding to the account payable keyed by the customer or its representative.

When the customer has handed over the payment order to the transfer agent the amount due is withdrawn from an account of the customer's choice. The transfer agent subsequently collects the payment orders submitted by its customers and sends them to a “clearing house”, which manages the total of all transfers from all its participating transfer agents to the account of the service provider. During this process there are additional steps in which the five data fields mentioned above are read from the payment orders.

The solution according to a preferred embodiment of the present invention aims to bridge the crucial step between man and machine when the five data fields are entered into a desired subsystem. In its design, the following concerns are addressed as design conditions:

Even though there are logical foundations to all five data fields they essentially don't exhibit any logical structure to the person entering them. At least not in the cases of the account and reference numbers.

Even though it is clear that all five data fields are necessary to specify any given payment order it is more logical to represent each order by a single data field.

In general the five data fields contain a total of up to 50 digits. It can be quite time-consuming and tedious to enter them into a computer.

Part from the reference number and the account number there are no error detecting features present.

On most European markets there are typically two competing clearing houses, each of these with an account number system of their own. It is quite common that customers confuse these account types and hence the amount is paid to the wrong account. I.e., the same account number represents two different accounts, one in each system.

The solution according to one preferred embodiment of the invention is to summarize all the information of the five data fields in a single code sequence, which is significantly shortened and much easier to remember and express for a user. This sequence, in one embodiment consists of a series of 32 different symbols, which can be alphanumerical, specifically the alphabet and decimal digits with the letters O and I as well as the digits 1 and 0 omitted. The reason not to use these is to not cause any confusion because of their similarities. See Table 1 below for an example of a code alphabet. The symbols are taken from a 32 base in a modulo mathematics.

The invoicing party through using the coding alphabet encodes the data corresponding to the payment order into a code and includes this in the payment order by printing it on the invoice or preferably on the payment order. When the information in the payment order needs to be referenced the code can be used given that the receiving system can translate it to the corresponding five data fields of the payment order. Two examples of such “translation” systems are described below.

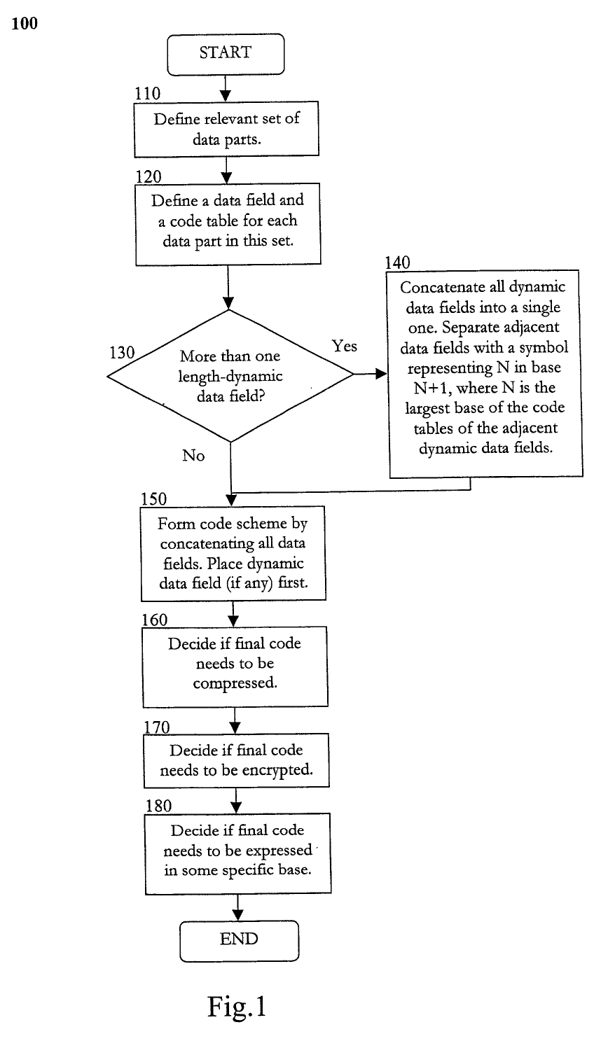

FIG. 1 illustrates a flowchart 100, describing steps for identifying a coding scheme, according to one embodiment of the present invention. The coding sequences initiates with defining a relevant set of data parts 110 on the bearer. A data field and a code table for each data part in the defined set are then defined 120. Any length-dynamic data fields are identified 130. When only one length-dynamic data field have been identified, concatenating all data fields then forms the code and a dynamic data field is then placed first 150. In case more than one length-dynamic data field have been identified, all dynamic data fields are concatenated into a single dynamic data field 140 before proceeding to 150. Adjacent data fields can in this case be separated with a symbol representing N in base N+1, where N is the largest base of the code tables of the adjacent dynamic data fields. A decision can be made whether or not to compress the final code 160. A further decision can then be made whether or not to encrypt the final code 170. A decision can also be made whether or not to express the final code in a specific base 180.

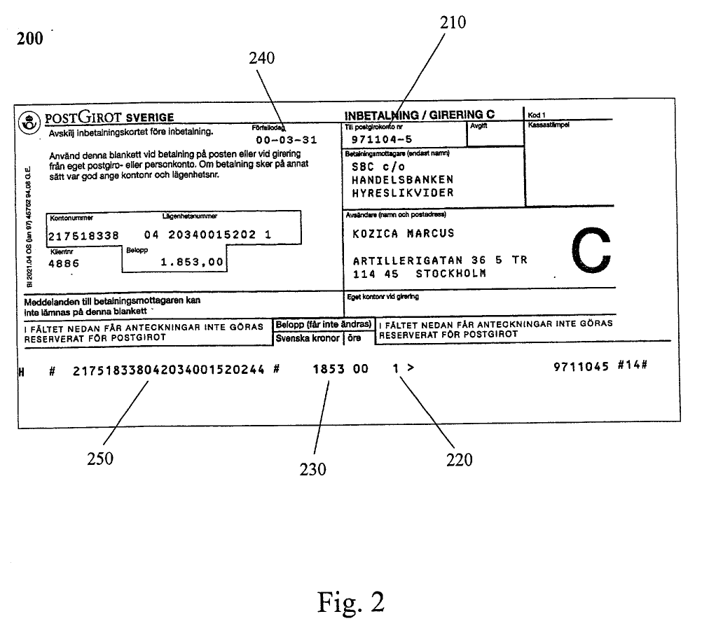

FIG. 2 illustrates a payment order 200 according to a preferred embodiment of the invention containing five data fields 210, 220, 230, 240, 250 of decimal digits of a structure exemplified in Table 2 below. Table 2 defines a data field account type, however this property is understood in FIG. 2 as being “postgiro” and the reference 220 here refers to a control number of the amount payable. This data field, “control number of the amount payable”, is not present in table 2, but can be calculated after decoding in this embodiment of the invention.

In one embodiment of the present invention, all the account information in the five fields 210, 220, 230, 240, 250 is summarized into one single code sequence. Two examples of methods for accomplishing this are described below, Example 1 and Example 2. The information in the above five fields are typically of different structure depending on local conditions on different markets. The coding scheme can be implemented with regards to locally prevailing differences. It is still necessary to observe the design conditions mentioned above.

### EXAMPLE 1

The first step in forming the code for a payment order 200 is to express the due date of payment with the code symbol alphabet, for example according to Table 1. Based on the observation that to specify a date in this context there is no need to use as many as eight decimal digits. That many digits gives a span of a total of 108 days (or more conservatively 10 000 years, roughly 4*10⁶ days) but for payments there are practical considerations to observe.

Given the assumption that there is no need to specify a date later (or any day earlier) than 100 years from Jan. 1, 2000 for a payment order there is only a need to specify one date out of all in 100 years. Moreover the billing and invoicing systems that generates the due date of payments are currently already generating valid dates, i.e., there are no dates with months between 13 and 99 or dates 32 to 99. Hence there is no need in the encoder of the present invention to validate a date. The encoding can alternatively also be preceded with a proper validation of all dates.

A date in the code is expressed by forming a “21^{st} century” with each month containing 31 days. This gives a span of 100*12*31=37 200 days as opposed to 10⁸ days.

An implementation of the encoder makes use of dynamic evolution of the encoding scheme. If there is a need in the future to, for example, start the date calculation from a later date than Jan. 1, 2000, this value can simply be reset in a software resource file.

Given a specific due date of payment on the form (during the 21^{st} century)

20 yy.mm.dd

where

0≦yy≦99 (or 88 as seen below)

1≦mm≦12

1≦dd≦31

Form the number

DATE=(yy*12+mm−1)*31+dd−1

0≦DATE≦37199

The code makes use of the base-32 digit system, for example according to Table 3 below. Base 2 and 11 are included for convenience.

To calculate the code for the due date of payment, the number DATE is expressed in base 32 given by the symbol sequence in Table 3. This is the same as converting to base 2 and perform a table look up in blocks of five bits to find the corresponding base-32 symbol sequence (similar to the usual binary to hexadecimal conversion). Since 32³=32 768 it is possible to discriminate all dates between Jan. 1, 2000 and Feb. 1, 2088 with three base-32 digits. As opposed to eight decimal digits used in the currently utilized scheme for payment orders. As described above, this span of dates is dynamic. To denote a “NULL” entry, i.e., no specified date in the payment order issued, DATE=0 is used.

In order to ensure uniqueness, the function DATE (yy, mm, dd) needs to be “one-to-one” on at least Z ([0,88], [1,12], [1,31]).

The second step in forming the code for a payment order is to form the decimal and base-11 hybrid number as, for example, shown in Table 4 below. The number 10 in base 11, Δ, is used as a separator in order to be able to parse the information when decoding. The final code segment is the base-32 equivalent of the base-11 intermediate number.

If it is desirable to represent a payment order with one, two or all three of the (number) fields blank it is possible to omit the corresponding number. It is sometimes customary to issue payment orders with, e.g., no amount specified, for example tax payment orders issued by the IRS.

The final code is then the concatenation of the DATE (always three base-32 digits), the above code segment and a final check sum of the previous digits modulus 32, which structure and code are exemplified in Tables 5 and 6 below.

### EXAMPLE 2

In order to minimize the resulting, final, code sequence there are some special features of the local payment market to observe:

There are two similar payment systems, “PostGirot” and “Bankgirot”.

It is unlikely that payment orders with due dates of payment extending one year in advance are issued.

The majority of all payments are made to a few service providers.

To utilize these three features the following types are defined:

Account Type Bit

Date Series

Account Compression Bit

Frequently Occurring Account Numbers

General Account Numbers

Check Sum and Date Series

Account Type Bit:

This is a binary digit where the value 0 (zero) denotes account type PostGirot and 1 (one) denotes Bankgirot.

Date Series:

This type can be either A or B. A date series is a list of 256 consecutive (however not necessarily adjacent) “possible” dates. A date is said to be “possible” if it is possible to order a payment on that specific date. Weekends and public holidays are not “possible” dates. Note that a year approximately contains 250 “possible” dates and that they are all known in advance.

In this exemplifying method the “Date Series” type alternates between A and B with one overlapping date. This overlapping preserves the ability to specify a “NULL” date, i.e., a payment order with no due date of payment specified.

Through this, all future dates can be referenced.

Account Compression Bit:

In order to minimize the number of bits required specifying an account number it is possible to implement the coding scheme with a set of predefined account numbers. It is for example efficient to use a list of the 128 most frequently occurring account numbers in each of the two different payment systems locally utilized. An account number in this set can be referenced with seven (7) binary bits. The type then has to be specified elsewhere.

The “Account Compression Bit” is a binary digit where the value 1 (one) denotes usage of the set of account numbers above. The value 0 (zero) denotes that account numbers are specified as is.

To form the code according to this example, different methods will be used depending on whether the account number is in the predefined account number set described above or not.

Frequently Occurring Account Numbers:

For the “Frequently Occurring Account Numbers”, the hybrid number is formed as depicted in Table 7 below and similarly as in Example 1. The first part is already binary (essentially base 32) but the latter needs to be converted from hybrid decimal and base 11 to base 32 before being concatenated with the first part below.

General Account Numbers:

The “General Account Numbers” is formed similarly as the “Frequently Occurring Account Numbers” above, and an example for forming the number is shown in table 8 below.

Check Sum and Date Series:

To be able to specify the different date series two different check sum algorithms are used (both sums are modulus 32). CA denotes “date series”=A and C_{B} denotes “date series”=B. (These series are of length 256 with one overlapping date.)

C_{A}=Σaₙ over all base-32 digits a

C_{B}=Σ(−1)ⁿaₙ over all base-32 digits a

Either of these two (base-32) numbers is finally concatenated to the code segment depending on which date series is used.

Additional Compression:

For additional compression it is possible, in both of the examples described above, to use an additional compression of the final base-32 (binary) number. For example, a “Lempel-Ziv” coding scheme could be used.

The resulting, near optimal, Lempel-Ziv table can be implemented in an encoder and a decoder, i.e., its comprised tree structure is not to be contained in the code sequence.

In an embodiment of the present invention, an ISO-standardized international reference to a specific account number can be implemented enabling to include additional extensions in the account number data field in order to reference international payment orders. This would also require an additional feature to the code scheme to be able to denote the currency type.

In some cases there are relations between different payment orders. For instance a customer can receive a collection of monthly payment orders. An extension of the coding scheme according to the present invention can summarize all the payment order data to a single code sequence if desired.

The total compression of the number of required digits to be able to uniquely specify a payment order will roughly be 50 percent.

By using a representation in base 32 the compression of a base-l 1 number will be

ln 11/ln 32≈0.69

However, in expressing the due date of payment there will be a reduction by several digits and the separating Δ's will require additional digits.

In the advent of mobile Internet access in general and of hand-held devices in particular there will probably be a future need to be able to swiftly specify a payment order on a hand-held device. With the code scheme according to the present invention this issue is by all means thoroughly addressed.

To additionally increase the ease of referencing a payment order, the code can be expressed in blocks of three digits. A typical code sequence would then look like the following:

GR4 S6B 83U DFK EVY

The structural form of a code sequence in accordance to one embodiment of the present invention is exemplified in Table 9 with reference to Table 10. The use of compression or encryption has not been yet decided in this example.

The code sequence can alternatively be distributed in a 2-dimensional grid or in a 3-dimensional lattice.

Means mentioned in the present description can be software means, hardware means or a combination of both.

The present invention has been described with non-limiting examples and embodiments. It is the attached set of claims that describe possible embodiments for a person skilled in the art.

TABLE 1
Code Alphabet

| A | B | C | D | E | F |
|---|---|---|---|---|---|
| G | H | — | J | K | L |
| M | N | — | P | Q | R |
| S | T | U | V | W | X |
| Y | Z | — | 2 | 3 | 4 |
| 5 | 6 | 7 | 8 | 9 | — |

TABLE 2

| Data Field | Length |
|---|---|
| Account payable | Approx. 10 decimal digits |
| Account type | One decimal digit¹ |
| Amount | Approx. 10 decimal digits |
| Due date of | 8 decimal digits |
| payment | |
| Reference | Up to 25 decimal digits² |
| number | |

¹This discriminates between 10 different account types.
²As is seen above this number can and usually does contain redundant digits.

TABLE 3

| Base | 2 | 10 | 11 | 32 |
|---|---|---|---|---|
| Number | 0 0000 | 0 | 0 | A |
| | 0 0001 | 1 | 1 | B |
| | 0 0010 | 2 | 2 | C |
| | 0 0011 | 3 | 3 | D |
| | 0 0100 | 4 | 4 | E |
| | 0 0101 | 5 | 5 | F |
| | 0 0110 | 6 | 6 | G |
| | 0 0111 | 7 | 7 | H |
| | 0 1000 | 8 | 8 | J |
| | 0 1001 | 9 | 9 | K |
| | 0 1010 | 10 | Δ | L |
| | 0 1011 | 11 | 10 | M |
| | 0 1100 | 12 | 11 | N |
| | 0 1101 | 13 | 12 | P |
| | 0 1110 | 14 | 13 | Q |
| | 0 1111 | 15 | 14 | R |
| | 1 0000 | 16 | 15 | S |
| | 1 0001 | 17 | 16 | T |
| | 1 0010 | 18 | 17 | U |
| | 1 0011 | 19 | 18 | V |
| | 1 0100 | 20 | 19 | W |
| | 1 0101 | 21 | 1Δ | X |
| | 1 0110 | 22 | 20 | Y |
| | 1 0111 | 23 | 21 | Z |
| | 1 1000 | 24 | 22 | 2 |
| | 1 1001 | 25 | 23 | 3 |
| | 1 1010 | 26 | 24 | 4 |
| | 1 1011 | 27 | 25 | 5 |
| | 1 1100 | 28 | 26 | 6 |
| | 1 1101 | 29 | 27 | 7 |
| | 1 1110 | 30 | 28 | 8 |
| | 1 1111 | 31 | 29 | 9 |

TABLE 4

| | Account | Account | | | | Reference |
|---|---|---|---|---|---|---|
| | Type | Number | Separator | Amount | Separator | Number |
| Hybrid | decimal | decimal | Δ | decimal | Δ | decimal |
| | digit | number | | number | | number |

| | |
|---|---|
| Intermediate | Base-11 number |
| Code | Base-32 number |
| Segment | |

TABLE 5
Final Code

| | | Check sum modulus |
|---|---|---|
| Date | Code segment | 32 |
| 3 base 32 digits | Base 32 number | 1 base 32 digit |

TABLE 6

| | Account | Account | | | | Reference | Check |
|---|---|---|---|---|---|---|---|
| Date | Type | Number | Separator | Amount | Separator | Number | Sum |
| 2002-03-14 | 0³ | 8200040 | Δ | 183900 | Δ | 30603101012⁴ | |

| DATE | Intermediate Base-11 Number |
|---|---|
| 819⁵ | 08200040Δ183900Δ306031010 |

Code Segment

| | | |
|---|---|---|
| A3V | HR5YY79ERX9P | F |

Final Concatenation
A3VHR5YY79ERX9PF
³In this example (taken from an actual Telia payment order) “account type” = 0 denotes “PostGirot”. Typically “account type” = 1 would then represent “Bankgiro.”
⁴In this example the last digit 2 is a check sum and the second-last digit 1 represents the fact that the total number of digits is 11 or more specifically the least significant digit of the total number of digits.

TABLE 7

| | Account | Account Type | Account Number | | | Reference |
|---|---|---|---|---|---|---|
| Date | Compression Bit | Bit | Reference | Amount | Separator | Number |
| 8 binary bits | 1 binary bit⁶ | 1 binary bit | 7 binary bits | decimal | Δ (base 11) | decimal |
| | | | | number | | number |

⁵Here expressed in base 10.
⁶This bit will have the value 1 (one) in this case.

TABLE 8

| | Account | Account | Account | | | | Reference |
|---|---|---|---|---|---|---|---|
| Date | Compression Bit | Type Bit | Number | Separator | Amount | Separator | Number |
| 8 binary bits | 1 binary bit⁷ | 1 binary bit | decimal | Δ (base | decimal | Δ (base | decimal |
| | | | number | 11) | number | 11) | number |

⁷This bit will have the value 0 (zero) in this case.

TABLE 9

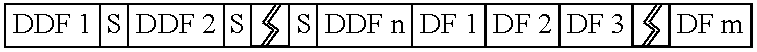

TABLE 10

| | |
|---|---|
| DDF | Dynamic Data Field |
| S | Separator |
| n | Number of Dynamic Data |
| | Fields |
| DF | Data Field |
| m | Number of Data Fields |

1. A code bearer provided for manual reading of a first code followed by an input of the first code to a machine, said bearer comprising at least one numerical data field comprising the first code as a series of multiple figures, characterized in that it is provided a second code generically specifying the numerical data field with the first code through modulo arithmetic with a predetermined base, represented by at least one symbol accomplished through compressing each series of multiple figures in the at least one data field into the at least one symbol representing the series of multiple figures through the utilized base in the modulo arithmetic, and concatenating said symbols in a predetermined pattern for entering into the machine, wherein enhanced readability of the first code through the symbol pattern applied for the first code is accomplished, thus providing an aid for facilitated, protected and error-minimized input of data connected to the first code into the machine.

2. A code bearer according to claim 1, wherein it is a piece of code-imprinted material.

3. A code bearer according to claim 1, wherein it is an electronic device connected to a display.

4. A code bearer according to one of claims 1-3, wherein it is an invoice or a bill.

5. A code bearer according to one of claims 1-4, wherein the comprised data fields contain data referring to at least one of account payable, account type, amount, due date of payment and reference number.

6. A code bearer according to claim 5, wherein the date during the 21^{st} century is determined by:
DATE=(yy*12+mm−1)*31+dd−1
0≦DATE≦37199 days.

7. A code bearer according to claim 6, wherein DATE is set to 0 for denoting a NULL entry of a date.

8. A code bearer according to one of claims 5-7, wherein the code is implemented with a set of predefined account numbers minimizing the number of bits required.

9. A code bearer according to claim 8, wherein the account numbers are specified in a list of the most frequently occurring account numbers in each of two different payment systems utilized.

10. A code bearer according to one of claims 1-9, wherein it is a receipt.

11. A code bearer according to one of claims 1-10, wherein it is a receipt for a purchase of a product or service.

12. A code bearer according to one of claims 1-11, wherein it is a receipt for a registration of a travel, accommodation or membership.

13. A code bearer according to one of claims 1-12, wherein it is a credit card, a membership card, a driver's licence, passport, id-card or a social security card.

14. A code bearer according to one of claims 1-13, wherein the machine is a computerized device with a screen.

15. A code bearer according to one of claims 1-14, wherein the machine is a computerized device with a display such as a PDA, a cellular telephone or the like.

16. A code bearer according to one of claims 1-15, wherein the machine is connected to a network for data or telecommunication.

17. A code bearer according to one of claims 1-16, wherein it is connected to the machine.

18. A code bearer according to one of claims 1-17, wherein the predetermined pattern is a number of symbols provided in spaced apart blocks.

19. A code bearer according to one of claims 1-18, wherein the coding scheme is reversed for decoding the second code back into the first code again upon entering the second code into the machine through a decoding means.

20. A code bearer according to one of claims 1-19, wherein the second code is substantially shorter than the first code.

21. A code bearer according to one of claims 1-20, wherein the second code comprises letters from at least one alphabet, numerals or a combination of letters and numerals.

22. A code bearer according to one of claims 1-21, wherein the second code comprises an error detection symbol.

23. A code bearer according to claim 22, wherein the error detection symbol is accomplished through adhering all the symbols in the second code through the modulo arithmetic with a predetermined base.

24. A code bearer according to one of claims 1-23, wherein an additional coding scheme is used for additional compression of the second code.

25. A code bearer according to one of claims 1-24, wherein multiple payment orders are summarized into a single code by an extension of the second code.

26. A code bearer according to one of claims 1-25, wherein the second code is computer readable through a scanning means.

27. A data-coding device for generating a second code from a first code on a code bearer in accordance to claim 1, said bearer comprising at least one numerical data field comprising the first code as a series of multiple figures, the device further comprising:
means for providing the second code via generically specifying the numerical data field with the first code through modulo arithmetic with a predetermined base;
means for compressing each series of multiple figures in the at least one data field into at least one symbol;
means for concatenating said symbols in a predetermined pattern for entering into a machine; and
wherein enhanced readability of the first code through the symbol pattern applied for the first code is accomplished, thus providing an aid for facilitated and error-minimized input of data connected to the first code into the machine.

28. A data-coding device according to claim 27, further comprising a printing means for printing the second code onto the bearer.

29. A data-coding device according to one of claims 27-28, further comprising a decoder means for decoding the second code into the first code upon entering the second code into the machine.

30. A data-coding device according to one of claims 27-29, further comprising a data field identifying means, for identifying length-dynamic data fields and length static data fields.

31. A data-coding device according to one of claims 27-30, wherein multiple length-dynamic data fields are arranged to be concatenated into a single length-dynamic data field.

32. A data-coding device according to one of claims 27-31, wherein the length-dynamic data field is arranged to be positioned first when the length-dynamic and length-static data fields are concatenated.

33. A data-coding device according to one of claims 27-31, wherein length-static data fields are concatenated when no length-dynamic data fields are identified.

34. A method for providing a code to a bearer in accordance to claim 1, said bearer comprising at least one numerical data field comprising the first code as a series of multiple figures, the method further comprising the steps of:
providing a second code generically specifying the numerical data field with the first code through modulo arithmetic with a predetermined base;
compressing each series of multiple figures in the at least one data field into the at least one symbol representing the series of multiple figures through the utilized base in the modulo arithmetic;
concatenating said symbols in a predetermined pattern for entering into the machine;
wherein enhanced readability of the first code through the symbol pattern applied for the first code is accomplished, thus providing an aid for facilitated, protected and error-minimized input of data connected to the first code into the machine.

35. A method according to claim 34, wherein the second code is printed onto the bearer.

36. A method according to claim 34, wherein the second code is provided electronically onto the bearer.

37. A method according to one of claims 34-36, wherein the coding scheme is reversed for the second code to be decoded into the first code subsequent to entering the second code into the machine.

38. A method according to one of claims 34-37, wherein the decoded data is extracted onto the fields of an electronic copy of the code bearer provided on a screen of the machine and in correspondence to the data fields of the original code bearer.

39. A method according to one of claims 34-38, wherein length-dynamic data fields and length static data fields are identified.

40. A method according to claim 39, wherein multiple length-dynamic data fields are concatenated into a single length-dynamic data field.

41. A method according to one of claims 39-40, wherein the symbols from a length-dynamic data field are positioned first for the concatenation.
